(19) United States
(12) Patent Application Publication
(10) Pub. No.: US 2006/0040695 A1
(43) Pub. Date: Feb. 23, 2006

(54) Method of group call service using push to talk scheme in mobile communication terminal

(75) Inventors: Sung-Jae Yoon, Gumi-si (KR); Chang-Min Oh, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/206,763

(22) Filed: Aug. 19, 2005

(30) Foreign Application Priority Data
Aug. 19, 2004 (KR) 2004-65341

(51) Int. Cl. H04B 7/00; H04Q 7/20

(52) U.S. Cl. 455/519; 455/507

(57) ABSTRACT

A method for performing a Push To Talk (PTT) group communication using a PTT scheme in a mobile communication terminal is disclosed. The method includes the steps of selecting one called user with whom a calling user wants to communicate through one-to-one communication from a PTT communication group of members that are taking part in the PTT group communication, performing a voice-record operation, if a predetermined Push To Data (PTD)-sending operation is executed for the one-to-one communication, and transmitting the voice-recorded PTD data to a PTT server which then transfers the voice-recorded PTD data to a called mobile communication terminal of the selected called user for the one-to-one communication. The PTT group communication allows two terminals to communicate with each other by a one-two-one scheme even while the PTT group communication is progressing.

### PRIORITY

This application claims the benefit under 35 U.S.C. §119(a) of Korean Patent Application, entitled “METHOD OF GROUP CALL SERVICE USING PUSH TO TALK SCHEME IN MOBILE COMMUNICATION TERMINAL” filed in the Korean Industrial Property Office on Aug. 19, 2004 and assigned Serial No. 2004-65341, the entire contents of which are hereby incorporated by reference.

### BACKGROUND OF THE INVENTION

1. Field of the Invention

The present invention relates to a mobile communication system using a Push To Talk (PTT) scheme. More particularly, the present invention relates to a method for providing PTT group call traffic service.

2. Description of the Related Art

The PTT is referred to as “a basic call traffic scheme” used for a walkie-talkie or a Handheld Transceiver (HT). The PTT scheme allows a user to communicate with the other party by properly operating PTT buttons disposed on, for example, a walkie-talkie. Specifically, in an operation for communication based on the PTT scheme, the user simply presses the PTT button when talking to the other party, and releases the pressed PTT button when listening to the other party's talk. Such a PTT scheme provides one-to-one or one-to-multiple party communication through which the users can simply and rapidly communicate with each other.

In recent years, conventional mobile communication systems have provided so called internet phone service of Voice over Internet Protocol (VoIP) scheme in which a predetermined Internet Protocol (IP) has been previously assigned to each of the terminals of the systems. Similar to the walkie-talkie or HT, such a VoIP scheme can also allow the mobile communication terminals to communicate with each other in the form of mobile communication PTT service which is capable of providing one-to-one or one-to-multiple communication.

Such a mobile communication PTT service can provide voice/data services through which multiple users or groups can communicate simultaneously with each other. In order to start the mobile communication PTT service, the user presses a PTT button disposed properly in the mobile communication terminal capable of providing the PTT service so that the PTT mobile communication terminal may send a PTT service request to a mobile communication network related therewith. Then, the mobile communication network denies or accepts the requested service to, in case of the acceptance, assign the requested resources based on the determination criterions such as availability of resources, priority of the requesting user, etc. When the requested service is accepted, the mobile communication network establishes connections among all the active users belonging to a certain user group. Consequently, the called mobile communication terminal outputs an alarm sound and message displays for indicating the received PTT call request to the corresponding called user who, then, recognizes the PTT call request to start a speaking or communication with the calling user. After establishing a voice traffic connection, the user who has requested a voice service can send the voice information to the other user who then can listen to the voice just sent.

As mentioned above, during such a mobile communication PTT service in which multiple users or groups can communicate simultaneously with each other through the voice/data service, all the mobile terminals of which all the users or the groups are now taking part in the PTT communication display or indicate thereon currently speaking contents which owners of current speaking permission are now saying. Therefore, all the subscribers included in one PTT communication group can know substantially what the speaking contents are.

In such a PTT group call traffic in which the multiple-users or groups may take part simultaneously, a certain user may like to communicate with a desired other party through one-to-one communication scheme without their talking contents exposed to the others of the group. In the prior art, to perform this one to one communication, the certain user should secede from the current PTT group communication and send a new one-to-one PTT call request message to a desired other party. And the desired other party, in other words, called user also should secede from the current PTT group communication like the certain user, in other words, the calling user mentioned above. Therefore, during conventional PTT group communication, it is time-consuming and tedious things to switch or change the current PTT group communication to the one-to-one PTT communication.

### SUMMARY OF THE INVENTION

Accordingly, the present invention has been made to solve the above-mentioned problems occurring in the prior art, and an object of the present invention is to provide a method for providing PTT group call traffic service in which it is possible to perform one-to-one Push To Talk (PTT) communication without terminating the PTT group call traffic service.

In order to accomplish this object, according to one aspect of the present invention, a method for performing a PTT group communication using a PTT scheme in a mobile communication terminal is provided. The method comprises the steps of selecting one called user with whom a calling user wants to communicate through one-to-one communication, from a PTT communication group members that are now taking part in the PTT group communication, performing a voice-record operation, if a predetermined Push To Data (PTD)-sending operation is executed for the one-to-one communication, and transmitting the voice-recorded PTD data to a PTT server which, then, transferring the voice-recorded PTD data to a called mobile communication terminal of the selected called user for the one-to-one communication.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic block diagram illustrating a mobile communication system using a Push To Talk (PTT) scheme according to an exemplary embodiment of the present invention;

FIG. 2a is a schematic block diagram illustrating a PTT mobile communication terminal according to an exemplary embodiment of the present invention;

FIG. 2b is an exterior view illustrating a PTT mobile communication terminal according to an exemplary embodiment of the present invention;

FIG. 3 is a flow chart illustrating a general PTT call traffic connection in the mobile communication system of FIG. 1; and

FIG. 4 a flow chart illustrating a Push To Data (PTD) calling operation in the PTT mobile communication terminal during a PTT group communication according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

Hereinafter, exemplary embodiments of the present invention will be described with reference to the accompanying drawings. The specific embodiments such as concrete constituent elements found in the following description are exemplary. Therefore, it will be understood by those skilled in the art that various changes in form and details may be made therein without departing from the spirit and scope of the invention.

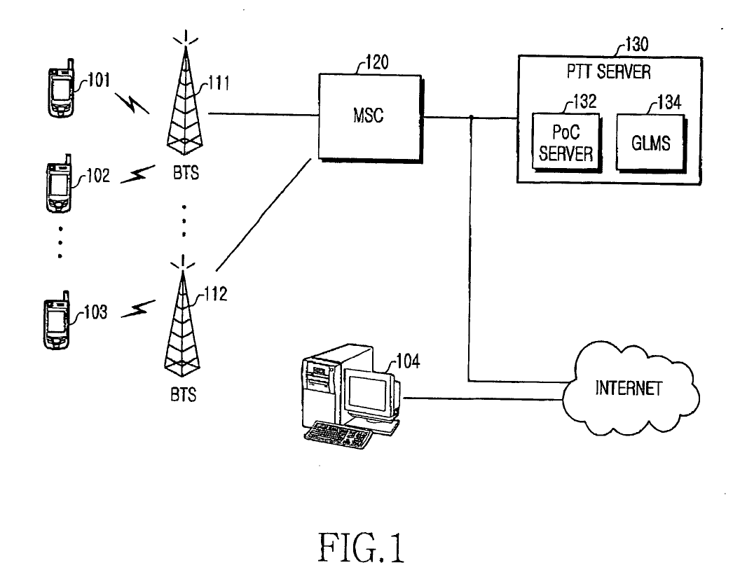

FIG. 1 is a schematic block diagram illustrating a mobile communication system using a Push To Talk (PTT) scheme according to an exemplary embodiment of the present invention. Referring to FIG. 1, the mobile communication system using the PTT scheme comprises generally a plurality of base station transceiver systems (BTSs) 111 and 112 which communicate with a plurality of mobile communication terminals 101, 102 and 103 located in the service coverage area of the BTSs to provide the mobile communication services. The plurality of base station transceiver systems (BTSs) 111 and 112 are connected to a mobile switching center (MSC) 120 which again is connected to a PTT server 130 via a data network.

The PTT server 130 performs real-time management operation for PTT user groups including general controlling for PTT user groups, mediating and holding of PTT communication requests, distributing of subscriber registration lists and call setups/separations of needed systems and network resources. Such a PTT server 130 comprises a PTT over Cellular (PoC) server 132 for performing a communication function for the PTT service in the mobile communication network, and a Group and List Management Server (GLMS) 134 for managing PTT subscribers' information and subscriber group list (called also as “buddy list”).

Each of the mobile communication terminals 101, 102 and 103 comprises a PTT module for performing PTT-related operations such as a PTT call request transferred to the PTT server 130 to wirelessly send the PTT call request in the form of previously and properly establish format to the BTSs 111 and 112 when operating the PTT call traffic. The MSC 120 receives the PTT call request from the BTSs 111 and 112 and provides the received PTT call request to the PTT server 130. The MSC 120 has an Inter Working Function (IWF) for processing certain data packets including such a PTT call request with the PTT server 130.

The users can connect their mobile communication terminals 101, 102 and 103 to the PTT server 130 to perform modification operations such as newly establishing, changing or deleting the group list information and the individual information which have been previously established by just the users. Alternatively, the user can connect their personal computer 104 to the PTT server 130 via the Internet to also modify the group list information and the individual information which have been previously established by just the user.

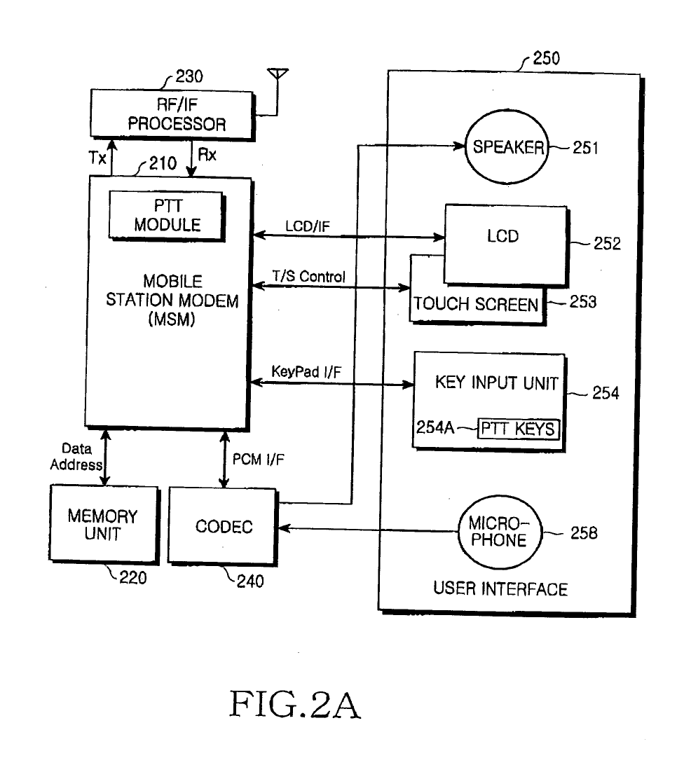

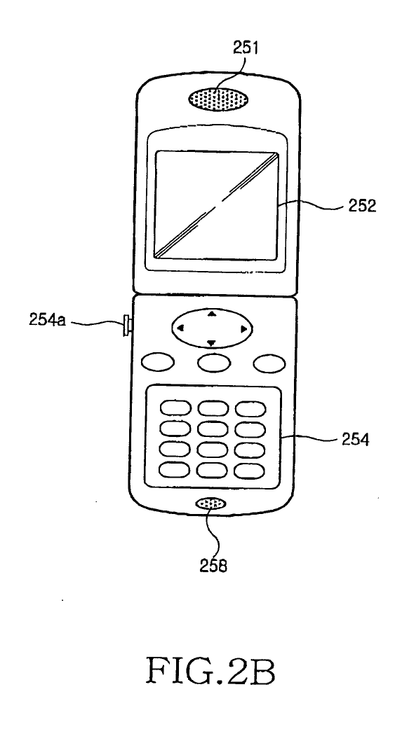

FIG. 2a is a schematic block diagram illustrating a PTT mobile communication terminal according to an exemplary embodiment of the present invention, and FIG. 2b is an exterior view illustrating a PTT mobile communication terminal according to an exemplary embodiment of the present invention. Referring to FIGS. 2a and 2b, the mobile communication terminal according to the principle of the present invention is capable of performing an interface operation with the user. The mobile communication terminal comprises a user interface 250, an radio frequency/intermediate frequencies (RF/IF) processor 230 for processing radio signals, a memory unit 220 having read only memory (ROM) and random access memory (RAM) for storing various operation programs and operation-related data, a voice signal processor/coder/decoder (CODEC) 240 for processing voice signals and a mobile station modem (MSM) 210 for taking a modem role as well as the role of a central processing unit for controlling the entire portion of a mobile communication terminal. The user interface 250 has a speaker 251, a display unit 252 such as Liquid Crystal Display (LCD), a key input unit 254 and a microphone 258.

Hereinafter, the operation of each function unit of the mobile communication terminal applied to the present invention will be described in detail. First, in the user interface 250, the microphone 258 converts the user's voice into an electric signal to send the electric signal to the voice signal processor/CODEC 240. In contrast, the speaker 251 receives an electric signal from the voice signal processor 240 and generates an audible sound based on the received electric signal. The key input unit 254 of the user interface 250 comprises a plurality of numeric/character keys for inputting numbers and characters, a plurality of function keys for performing the mobile communication functions, and dedicated PTT keys 254a for performing the PTT functions. Such a key input unit 254 transfers key input data to the mobile station modem 210 when the user inputs the related certain data or information through the keys of the unit. Although the dedicated PTT keys 254 are disposed in the separate form from the other keys on the key input unit as shown in FIG. 2a, the PTT keys may be implemented by using a part of the known or conventional keys. The display unit/LCD 252 which is typically formed of LCD comprises generally an LCD controller, a memory for storing image data and LCD display elements. The display unit 252 displays characters or number information such as a current condition of the mobile communication terminal or background images related therewith. The display unit 252 may have a touch screen 253 for the LCD.

The RF/IF processor 230 comprises an RF transmitter (not shown) for up-converting frequencies of the signals to be transmitted and amplifying the signals, and an RF receiver (not shown) for low-noise amplifying received signals and down-converting the frequencies of the received signals. The RF/IF processor 230 receives modulated signals from the mobile station modem 210, converts the modulated signals into intermediate frequencies (IF). Also, the RF/IF processor 230 converts the intermediate frequencies into radio frequencies (RF) to be output to the BTSs via an antenna. Furthermore, the RF/IF receives the radio signals from the BTSs via an antenna so that the received radio signals are converted sequentially into the intermediate frequencies and the baseband to be provided to the mobile station modem 210.

The voice signal processor 240 which is typically formed of audio CODEC receives analog voice signals from the microphone 258 to convert the received analog voice signals into digital signals/pulse code modulation (PCM) which are transmitted to the mobile station modem 210. Also, the voice signal processor 240 receives digital signals (PCM) of an other party's voice from the mobile station modem 210 to convert the received digital signals to the analog signals to be output to the speaker 251. Although the voice signal processor 240 is designed in the separate form as shown in FIG. 2a, the processor 240 may be embedded integrally in the mobile station modem so that the processor and the modem may be combined together in the form of one chip.

The mobile station modem 210 can perform various functions of the mobile communication terminal in accordance with the key data input through the key input unit 254, while the various information such as current states and user menu may be displayed on the display unit based on the performing of the functions. Especially, in the case of processing the voice signals for phone traffic, the mobile station modem 210 receives the PCM voice signals from the voice signal processor 240, and converts and modulates the received PCM voice signals by channel coding and interleaving to provide the converted and modulated signals to the RF/IF processor 230. Further, the mobile station modem 210 receives the voice signals provided from the RF/IF processor 230 and processes the received voice signals through demodulating, equalizing, channel decoding and de-interleaving to generate the resultant PCM voice signals which are then sent to the voice signal processor 240. Furthermore, the mobile station modem 210 has a PTT module for performing the PTT call traffic operation, especially one-to-one call traffic operation during the PTT group call traffic based on the characteristics of the present invention.

In operation of the mobile communication terminal shown in FIG. 2a and 2b, if the user performs dialing operation and setting operation for a calling mode through the key input unit 254, then the mobile station modem 210 monitors those operations and processes the input dialing information to then convert the input dialing information into corresponding radio signals through the RF/IF processor 230 to be output. Next, response signals are received from the other party's terminal via the RF/IF processor 230 in the mobile station modem 210 so that the received response signals may be output to the speaker 251 via the voice signal processor 240 to consequently form a voice traffic path for communication. In case of the called mode, the mobile station modem 210 monitors just the called mode through the RF/IF processor 230, and directs the voice signal processor 240 to generate corresponding ring signals. Next, similar to the calling mode, when the other party sends response signals, the mobile station modem 210 monitors that response signals which may be output to the speaker 251 via the voice signal processor 240 to consequently form a voice traffic path for communication. As mentioned above, only the exemplary voice communication was described for both the calling and the called modes according to an embodiment of the present invention. However, alternatively, data communication functions for packet data and image data and the PTT communication operation based on PTT key inputs also can be applied to the present invention.

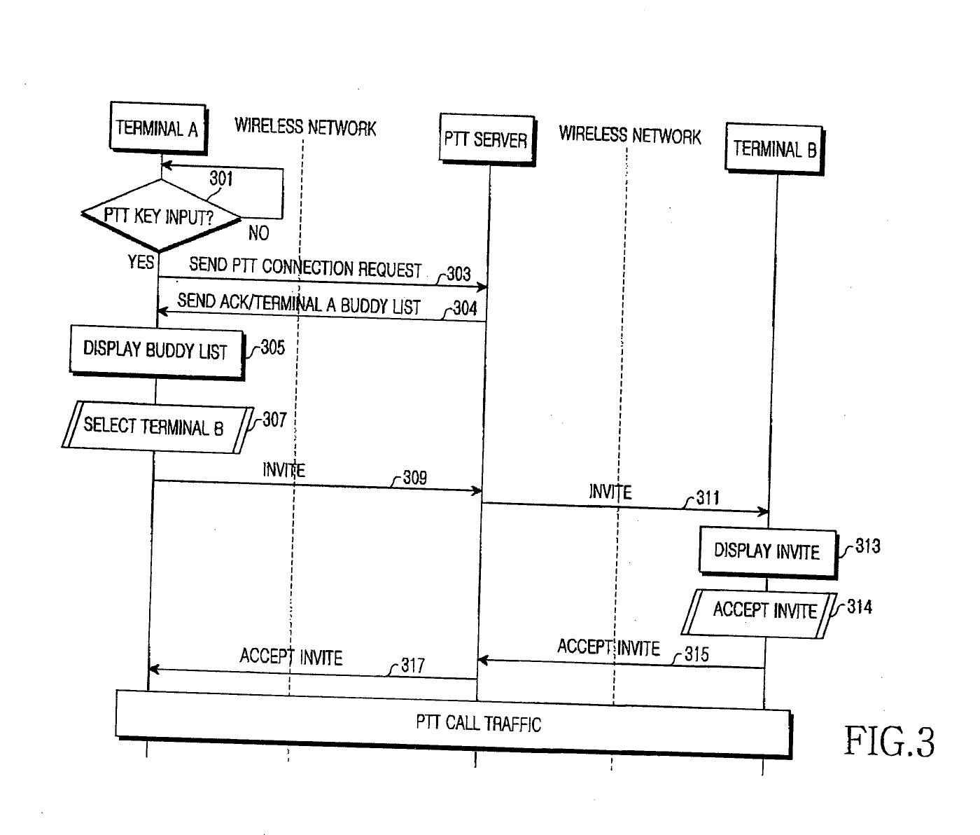

FIG. 3 is a flow chart illustrating a general PTT call traffic connection in the mobile communication system of FIG. 1. Referring to FIG. 3, firstly, if the user who wants the PTT communication inputs the PTT key disposed on a mobile communication terminal (terminal A in FIG. 3) or operates PTT call functions by menu setting operation, then in step 301, the mobile station modem confirms the PTT key input or the operation of the PTT call functions to drive PTT application. Next, in step 303, the mobile station modem sends the PTT connection request message to the PTT server via the wireless network. If the PTT server confirms the corresponding user who has previously sent the PTT connection request message through the GLMS server, then in step 304, the PTT server acknowledges the PTT connection request of the corresponding user and sends a buddy list which is a subscriber information of the terminal A PTT call traffic group, to the corresponding user, in other words, sending ACK/terminal A buddy list. Accordingly, the mobile station modem of the terminal A receives such a buddy list so that the display unit may properly display the buddy list in step 305. Referring to the displayed buddy list, the user of the terminal A can operate predetermined direction keys to select the other party who the user wants to communicate with through the PTT scheme. Specifically, in step 307, the mobile communication terminal (terminal A) inputs the selected other party or the selected subscriber (in case of FIG. 3, terminal B) by the user's operation. Next, in step 309, the mobile communication terminal (i.e., terminal A) sends a PTT call request message (referred to as “INVITE”) for the selected subscriber (i.e., the terminal B) to the PTT server via the wireless network. Such a PTT call request message (INVITE) comprises, for example, ID information of the calling or called party.

Hereinafter, a description will be made in greater detail about the step that the mobile communication terminal (TERMINAL A) sends the PTT call request (INVITE) to the PTT server. Above all, the mobile communication terminal (terminal A) sends the PTT call request message (INVITE) in the form of Short Data Burst (SDB) to the base station to which the terminal A is connected. Then, the mobile communication terminal (terminal A) negotiates (nego) with the base station for service option (SO_PTT) to provide the PTT service, and performs Traffic Channel (TCH) setup. The term “nego” indicates process for preparing for higher network sessions which are ranged from physical layers comprising Point-to-Point Protocol (PPP) session to application layers.

After this, the base station sends the PTT call request message (INVITE), to the PTT server which then confirms the ID of the called party based on the received message (INVITE). Next, in step 311, the PTT server sends the PTT call request message (INVITE) to the called mobile communication terminal (terminal B). Then, the called mobile communication terminal (terminal B) receives the PTT call request message (INVITE), and in step 313, informs the receipt of the PTT call request message (INVITE) to the corresponding user by sounding the predetermined alarm sound and displaying the predetermined alarm message.

Steps 311 and 313 will be described in greater detail as follow. The PTT server sends the PTT call request message (INVITE) to a corresponding base station which provides the services to the called mobile communication terminal (terminal B). The corresponding base station for the called mobile communication terminal sends periodically a paging signal (General Page (GP)) to the called mobile communication terminal (terminal B) which then sends the corresponding response signal (Page Response (PS)) for the GP to the corresponding base station. During such a paging process, the base station sends the PTT call request message (INVITE) in the form of SDB to the called mobile communication terminal (terminal B). Then, the called mobile communication terminal informs the receipt of the PTT call request message (INVITE) to the called user. At the same time, the called mobile communication terminal (terminal B) sends acknowledgement of the normal receipt of the PTT call request message (INVITE) to the base station.

By the way, if the called user has recognized the receipt of the PTT call request message (INVITE) in step 313, the called user can allow or accept the corresponding PTT call request by operating the predetermined keys such that, in step 314, the called mobile communication terminal (terminal B) can receive the key inputs for accepting the PTT call request, and in step 315 can send the PTT call request acceptance message to the PTT server via the wireless network. In step 317, the PTT server informs just the PTT call request acceptance to the calling mobile communication terminal (terminal A) to allow calling through the PTT call traffic.

Steps 315 and 317 will be described in greater detail as following. When sending the PTT call request acceptance, the called mobile communication terminal (Terminal B) sends the PTT call request acceptance message (so called “200 OK”) in the form of SDB to a corresponding base station. Then, the called mobile communication terminal (terminal B) negotiates (nego) with the corresponding base station for service option (SO_PTT) to provide the PTT service, and performs Traffic Channel (TCH) setup. The PTT call request acceptance message (200 OK) originated in the called mobile communication terminal (terminal B) is transferred finally to the calling mobile communication terminal (terminal A) via the base station of the called party, the PTT server and the base station of the calling party. The calling mobile communication terminal (terminal A) receives the PTT call request acceptance message to complete the traffic channel setup. Also, the calling mobile communication terminal informs the PTT call request acceptance to its user by displaying the alarm message through the display unit.

After this, in the PTT call traffic between the calling and the called mobile communication terminals, a specific terminal (for example, terminal A) sends a speaking right request message referred to as “Session Initiation Protocol (SIP) Ack” to the PTT server. Then, the PTT server controls the speaking permission requests between the terminals to grant the speaking permission to a predetermined mobile communication terminal. The mobile communication terminal which has obtained the speaking right transmits, in real-time, the talk bursts to the PTT server through a Real Time Protocol (RTP). The PTT server performs firstly buffering of the talk burst to transmit the buffered talk burst to the called mobile communication terminal through the RTP.

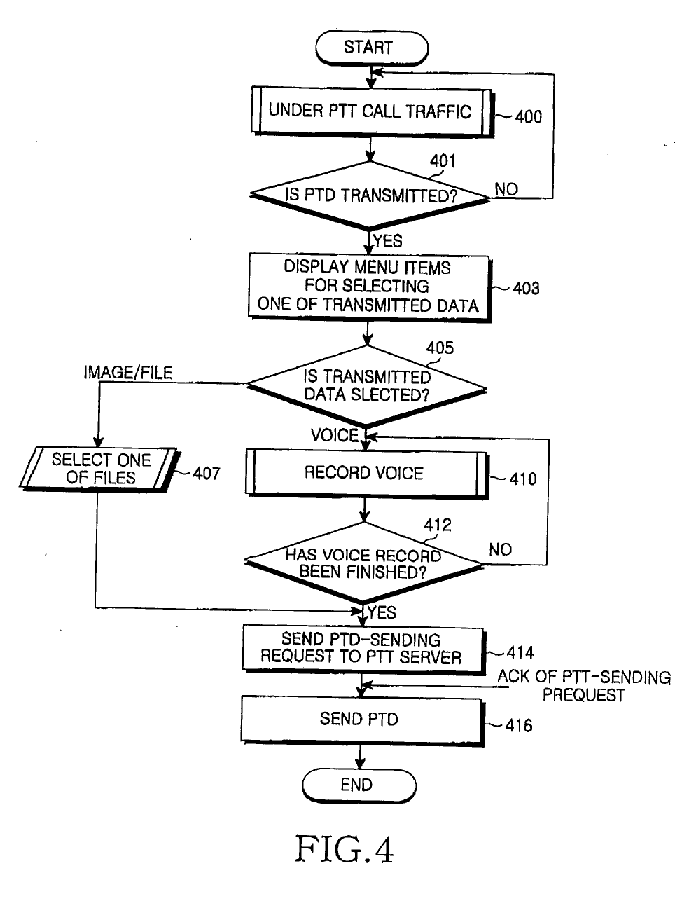

FIG. 4 is a flow chart illustrating a Push To Data (PTD) calling operation in the PTT mobile communication terminal during a PTT group communication according to an exemplary embodiment of the present invention. Referring to FIG. 4, in step 400, the mobile communication terminal is operating under the PTT call traffic as shown in FIG. 3. At this time, the user may select a particular other party from a buddy list which are now being displayed on the terminal.

In this situation, if the user tries to change the current group PTT call traffic into an one-to-one call traffic through which the user wants to communicate with a specific other party, the user may select and input ‘PTD calling’ item from a plurality of menu items which have been previously formed according to an exemplary embodiment of the present invention. When such a PDT calling menu item has been selected and input by the user, then the mobile communication terminal monitors just the input key in step 401. Next, the process proceeds to step 403 wherein the mobile communication terminal displays calling data selection menu items. For example, the user may select an image file menu item so that the selected image file previously stored in the memory unit may be transmitted to the other party. Also, the user may select a voice record menu item for recording her/his voice to be transmitted to the other party through one-to-one communication. Such a voice record menu item is displayed in step 403 for the user's selection. The mobile communication terminal monitors the user's choice from the menu items displayed thereon in step 405. If the user selects the image file item mentioned above, then the process proceeds to step 407, whereas if the user selects the voice record item, then the process proceeds to step 410. In step 407, the mobile communication terminal displays the previously stored file list from which the user may select one item by using ‘direction keys’ and ‘confirmation key or return key’. If the user finishes her/his selection, then the process proceeds to step 414.

In step 410, the user records her/his voice to be transmitted to the other party through one-to-one communication. The mobile communication terminal may provide typically a voice record function for such a user's record. In this case, because the mobile communication terminal is now taking part in the PTT group communication, the voice signal processor (CODEC) 240 in the mobile communication terminal is now operating the process of the PTT group call traffic message transmitted from the PTT server. Therefore, the mobile station modem 210 of the mobile communication terminal may perform a temporary buffering of the current PTT group call traffic message to the memory unit 220 to control the voice signal processor 240 for recording the user's voice. If completing the voice record process, the mobile station modem 210 controls the voice signal processor (240) to process the voice signals for the PTT group call traffic. The PTT group call traffic message, which has been temporally buffered in the memory unit 220, can be properly output by the user's operation after termination of the PTT group call traffic. Of course, during the voice record, the PTT group call traffic message transmitted from the PTT server may be discarded without being buffered in the memory unit. Like this, in step 410, if finishing the voice record, the user may input a confirmation key for confirming the finishing of the voice record in step 412. Next, the process proceeds to step 414.

In step 414, the mobile communication terminal transmits the PTD-send request message to the PTT server. If receiving the PTD send-request acknowledge message from the PTT server, then in step 416, the mobile communication terminal performs the PTD-sending operation. This PTD-sending operation in step 416 comprises, for example, a step of sending the file selected in step 407 to the PTT server, or a step of sending the voice file recorded in step 410 to the PTT server so that the selected file or the recorded voice file may be transmitted to the called mobile communication terminal which the calling user (or the caller) has selected from the buddy list displayed on her/his terminal when the PTT call traffic is operating.

As shown in FIG. 4, the present invention provides the PTD-sending operation in which the voice-recorded files can be transmitted for one-to-one communication during the PTT group call traffic between the mobile communication terminals. When receiving the sent voice-recorded file, the called mobile communication terminal informs the receipt of the recorded file to the called user by a predetermined alarm message. Then, if the called user performs a predetermined operation of her/his terminal in order to confirm what is the received data (i.e., the sent voice-recorded file), the called mobile communication terminal displays the received and voice-recorded data thereon. Of course, in this case, because the voice signal processor of the called mobile communication terminal is now performing the process of the PTT group call traffic message transmitted from the PTT server, the current PTT group call traffic message is buffered by the memory unit such that it is possible to perform the voice processing of the received PTD data. Such a PTT group call traffic message which has been buffered temporally in the memory unit may be output by the user's predetermined operation after termination of the PTT group call traffic. Also, in this case, the PTT group call traffic message transmitted from the PTT server may be discarded without buffering of it.

As mentioned above, the one-to-one communication can be performed even during the PTT group call traffic between the mobile communication terminals in the mobile communication system according to an exemplary embodiment of the present invention. While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for performing a Push To Talk (PTT) group communication using a PTT scheme in a mobile communication terminal, the method comprising the steps of:
selecting one called user, with whom a calling user wants to communicate through one-to-one communication, from a PTT communication group of members that are taking part in the PTT group communication;
performing a voice-record operation, if a predetermined Push To Data (PTD)-sending operation is executed for the one-to-one communication; and
transmitting the voice-recorded PTD data to a PTT server which transfers the voice-recorded PTD data to a called mobile communication terminal of the selected called user for the one-to-one communication.

2. The method as claimed in claim 1, wherein, in the step of performing the voice-record operation, PTT group call traffic messages currently being received are temporally buffered.

3. The method as claimed in claim 1, wherein, in the step of performing the voice-record operation, group call traffic messages currently being received are discarded.

4. A method for performing a Push To Talk (PTT) group communication using a PTT scheme in a mobile communication terminal, the method comprising the steps of:
selecting one called user, with whom a calling user wants to communicate through one-to-one communication, from a PTT communication group of members that are taking part in the PTT group communication;
displaying menu items for the user to select one of two operations, when the user performs a Push To Data (PTD)-sending operation in a mobile communication terminal, wherein the two operations comprise a first operation for sending one of previously stored files and a second operation for recording a voice;
performing the second operation for recording the voice, if the menu item for the second operation is selected; and
transmitting the voice-recorded PTD data to a PTT server which transfers the PTD data to a mobile communication terminal of the selected called user for one-to-one communication.

5. The method as claimed in claim 4, wherein the method further comprises:
selecting a desired file from among the previously stored files, if the menu item for the first operation is selected; and
transmitting the selected file to the PTT server which then transfers the selected file to the mobile communication terminal of the selected called user for one-to-one communication.

6. The method as claimed in claim 4, wherein, in the step of performing the second operation for recording the voice, PTT group call traffic messages currently being received are temporally buffered.

7. The method as claimed in claim 5, wherein, in the step of performing the second operation for recording the voice, PTT group call traffic messages currently being received are temporally buffered.

8. The method as claimed in claim 4, wherein, in the step of performing the second operation for recording the voice, group call traffic messages currently being received is discarded.

9. The method as claimed in claim 5, wherein, in the step of performing the second operation for recording the voice, group call traffic messages currently being received is discarded.

10. Program code embodied on a computer-readable medium comprising:
a first set of instructions for selecting one called user, with whom a calling user wants to communicate through one-to-one communication, from a Push To Talk (PTT) communication group of members that are taking part in the PTT group communication;
a second set of instructions for performing a voice-record operation, if a predetermined Push To Data (PTD)-sending operation is executed for the one-to-one communication; and
a third set of instructions for transmitting the voice-recorded PTD data to a PTT server which transfers the voice-recorded PTD data to a called mobile communication terminal of the selected called user for the one-to-one communication.

11. Program code as claimed in claim 10, wherein said second set of instructions for performing the voice-record operation, PTT group call traffic messages currently being received are temporally buffered.
